(19) United States
(12) Patent Application Publication
(10) Pub. No.: US 2018/0061356 A1
(43) Pub. Date: Mar. 1, 2018

(54) DISPLAY DRIVER AND LIQUID CRYSTAL DISPLAY DEVICE

(71) Applicant: Japan Display Inc., Minato-ku (JP)

(72) Inventors: Masahiro TADA, Tokyo (JP); Hiroyuki KIMURA, Tokyo (JP); Takashi NAKAMURA, Tokyo (JP)

(73) Assignee: Japan Display Inc., Minato-ku (JP)

(21) Appl. No.: 15/657,459

(22) Filed: Jul. 24, 2017

(30) Foreign Application Priority Data
Aug. 23, 2016 (JP) 2016-162992

(51) Int. Cl. G09G 3/36; G09G 3/34

(52) U.S. Cl. CPC G09G 3/3688; G09G 3/3655; G09G 2370/08; G09G 3/3614; G09G 3/342

(57) ABSTRACT

According to one embodiment, a display driver includes a driving unit. The driving unit applies a common voltage to a common electrode, and alternately supplies a video signal having a first polarity and the video signal having a second polarity different from the first polarity to a pixel electrode in each frame period. The driving unit adjusts the common voltage applied to the common electrode based on information of a drive frequency of the video signal.

### CROSS-REFERENCE TO RELATED APPLICATIONS

This application is based upon and claims the benefit of priority from Japanese Patent Application No. 2016-162992, filed Aug. 23, 2016, the entire contents of which are incorporated herein by reference.

### FIELD

Embodiments described herein relate generally to a display driver and a liquid crystal display device.

### BACKGROUND

In general, a liquid crystal display device comprises an array substrate, a counter-substrate, a liquid crystal layer held between the substrates, and a color filter formed in one of the substrates. The gap between the array substrate and the counter-substrate is maintained constant by spacers. Various modes such as a twisted nematic (TN) mode are used for the display system of the liquid crystal display device. Each pixel comprises a thin-film transistor (TFT).

In many cases, the liquid crystal display device is driven with a drive frequency (frame rate) of 60 Hz. The power consumption can be reduced by decreasing the drive frequency. However, when the drive frequency is changed, a flicker or image burn-in may be generated on the screen of the liquid crystal display device.

### BRIEF DESCRIPTION OF THE DRAWINGS

FIG. 1 is a perspective view showing the structure of a liquid crystal display device according to one embodiment.

FIG. 2 is a cross-sectional view showing a liquid crystal display panel shown in FIG. 1.

FIG. 3 is a circuit diagram showing the structure of the liquid crystal display device.

FIG. 4 is a cross-sectional view showing a part of the liquid crystal display panel.

FIG. 5 is a circuit diagram showing some structures of the liquid crystal display device according to an example 1 of the embodiment.

FIG. 6 is a graph showing a change in the common voltage in accordance with the drive frequency in the liquid crystal display device of the example 1.

FIG. 7 is a circuit diagram showing some structures of the liquid crystal display device according to an example 2 of the embodiment.

FIG. 8 is a circuit diagram showing some structures of the liquid crystal display device according to an example 3 of the embodiment.

FIG. 9 is a graph showing a change in the corrected common voltage in accordance with the common current in the liquid crystal display device of the example 3.

FIG. 10 is a graph showing a change in the common current in accordance with time in the liquid crystal display device of the example 3.

FIG. 11 is a circuit diagram showing some structures of the liquid crystal display device according to an example 4 of the embodiment.

FIG. 12 is a graph showing a change in the corrected common voltage in accordance with the difference in liquid crystal capacitance in the liquid crystal display device of the example 4.

FIG. 13 is a circuit diagram showing some structures of the liquid crystal display device according to an example 5 of the embodiment.

FIG. 14 is a graph showing a change in the corrected common voltage in accordance with the voltage of a common electrode in a floating state in the liquid crystal display device of the example 5.

FIG. 15 is a plan view showing the common electrode of the liquid crystal display device according to an example 6 of the embodiment.

FIG. 16 is a circuit diagram showing some structures of the liquid crystal display device of the example 6.

FIG. 17 is a graph showing a change in the common voltage in accordance with the drive frequency in each area of the liquid crystal display device of the example 6.

FIG. 18 is a plan view showing the common electrode of the liquid crystal display device according to an example 7 of the embodiment.

FIG. 19 is a circuit diagram showing some structures of the liquid crystal display device of the example 7.

FIG. 20 is a plan view showing the common electrode of the liquid crystal display device according to an example 8 of the embodiment.

FIG. 21 is a circuit diagram showing some structures of the liquid crystal display device of the example 8.

### DETAILED DESCRIPTION

In general, according to one embodiment, there is provided a display driver comprising a driving unit which, with respect to a liquid crystal display panel comprising a pixel electrode, a common electrode and a liquid crystal layer, applies a common voltage to the common electrode, and alternately supplies a video signal having a first polarity and the video signal having a second polarity different from the first polarity to the pixel electrode in each frame period. The driving unit adjusts the common voltage applied to the common electrode based on information of a drive frequency of the video signal.

According to another embodiment, there is provided a liquid crystal display device comprising: a liquid crystal display panel comprising a pixel electrode, a common electrode and a liquid crystal layer; and a display driver comprising a driving unit which applies a common voltage to the common electrode, and alternately supplies a video signal having a first polarity and the video signal having a second polarity different from the first polarity to the pixel electrode in each frame period. The driving unit adjusts the common voltage applied to the common electrode based on information of a drive frequency of the video signal.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

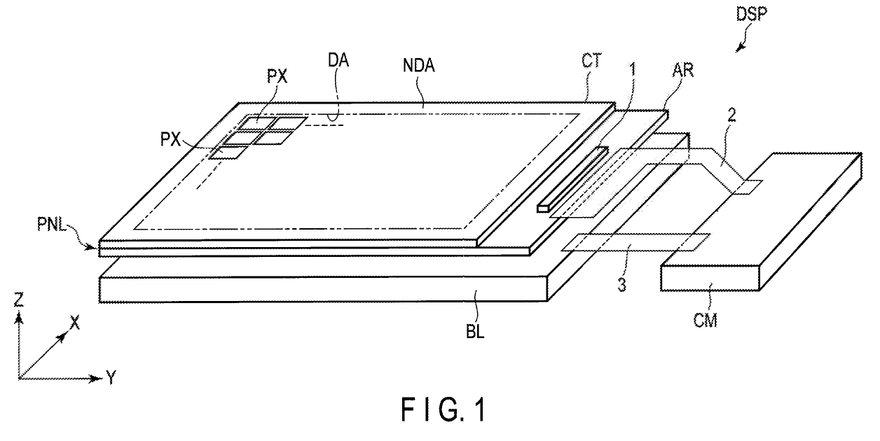

This specification explains the details of a liquid crystal display device of an embodiment with reference to the accompanying drawings. FIG. 1 is a perspective view showing the structure of a liquid crystal display device DSP. In the present embodiment, a first direction X is perpendicular to a second direction Y. However, the first direction X and the second direction Y may intersect each other at an angle other than a right angle. A third direction Z is perpendicular to each of the first and second directions X and Y.

As shown in FIG. 1, the liquid crystal display device DSP comprises an active-matrix liquid crystal display panel PNL, a driver IC 1 which drives the liquid crystal display panel PNL, a backlight unit BL which illuminates the liquid crystal display panel PNL, a control module CM, flexible printed circuits 2 and 3, etc.

The liquid crystal display panel PNL comprises an array substrate AR, and a counter-substrate CT facing the array substrate AR. The liquid crystal display panel PNL comprises a display area DA which displays an image, and a frame-like non-display area NDA which surrounds the display area DA. The liquid crystal display panel PNL comprises a plurality of pixels PX arrayed in matrix in the first and second directions X and Y in the display area DA.

The backlight unit BL is provided on the rear surface of the array substrate AR. Various forms may be applied to the backlight unit BL. However, the explanation of the detailed structure thereof is omitted. The driver IC 1 is mounted on the array substrate AR. The flexible printed circuit 2 couples the liquid crystal display panel PNL with the control module CM. The flexible printed circuit 3 couples the backlight unit BL with the control module CM.

The liquid crystal display device DSP having the above structure is equivalent to a transmissive type liquid crystal display device, which displays an image by causing each pixel PX to selectively transmit light entering the liquid crystal display panel PNL from the backlight unit BL. However, the liquid crystal display device DSP may be a reflective type liquid crystal display device, which displays an image by selectively reflecting outside light entering the liquid crystal display panel PNL from outside on each pixel PX, or may be a transreflective liquid crystal display device having both a transmissive function and a reflective function.

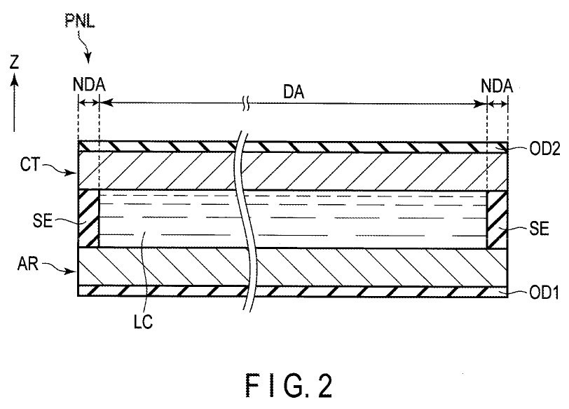

FIG. 2 is a cross-sectional view showing the liquid crystal display panel PNL.

As shown in FIG. 2, the liquid crystal display panel PNL comprises the array substrate AR, the counter-substrate CT, a liquid crystal layer LC, a sealing member SE, a first optical element OD1, a second optical element OD2, etc. The details of the array substrate AR and the counter-substrate CT are described later.

The sealing member SE is provided in the non-display area NDA, and is used to bond the array substrate AR to the counter-substrate CT. The liquid crystal layer LC is held between the array substrate AR and the counter-substrate CT. The first optical element OD1 is provided on the array substrate AR on a side opposite to the contact surface with the liquid crystal layer LC. The second optical element OD2 is provided on the counter-substrate CT on a side opposite to the contact surface with the liquid crystal layer LC. Each of the first and second optical elements OD1 and OD2 comprises a polarizer. The first and second optical elements OD1 and OD2 may include another optical element such as a retardation film.

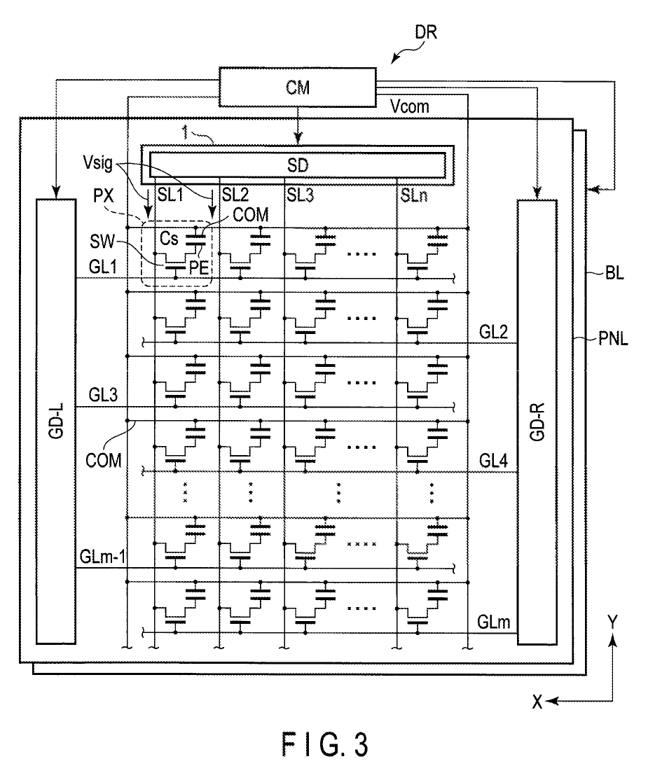

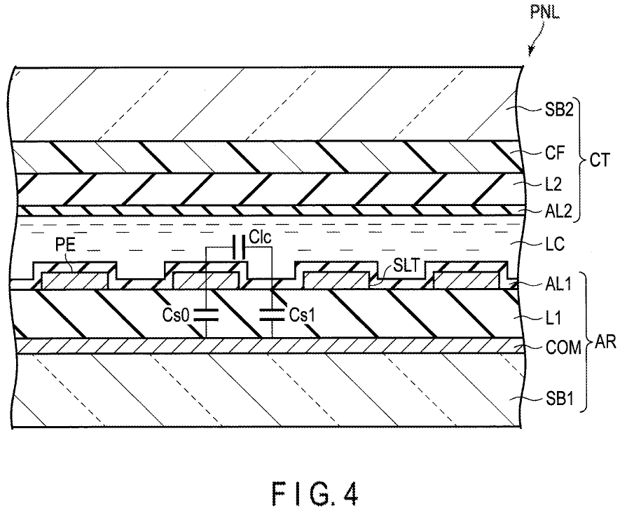

FIG. 3 is a plan view showing the structure of the liquid crystal display device DSP. FIG. 4 is a cross-sectional view showing a part of the liquid crystal display panel PNL. In the drawings, only the main structures necessary for explanation are shown.

As shown in FIG. 3 and FIG. 4, a transparent insulating substrate SB2, a color filter CF, an overcoat layer L2 and an alignment film AL2 are provided in the counter-substrate CT. The color filter CF includes a plurality of colored layers provided on the insulating substrate SB2 and corresponding to respective colors. For example, the color filter CF includes red (R), green (G) and blue (B) colored layers. The overcoat layer L2 is provided so as to cover the color filter CF, and prevents the substances contained in the color filter CF from flowing out to the liquid crystal layer LC. The alignment film AL2 faces the array substrate AR, and is in contact with the liquid crystal layer LC. In the present embodiment, the liquid crystal layer LC is formed of a negative liquid crystal material.

The array substrate AR comprises an insulating substrate SB1, a common electrode (counter-electrode) COM, an insulating layer L1, a plurality of pixel electrodes PE and an alignment film AL1. The pixel electrodes PE are formed on the insulating layer L1 such as silicon nitride (SiN), and face the common electrode COM. Each of the pixel electrodes PE is provided for a corresponding pixel PX. A slit-like aperture portion SLT is formed in each pixel electrode PE. The pixel electrodes PE are provided between the common electrode COM and the alignment film AL1. The common electrode COM and the pixel electrodes PE are formed of, for example, indium tin oxide (ITO) as a transparent conductive material. One side of the alignment film AL1 is in contact with the pixel electrodes PE. The other side of the alignment film AL1 is in contact with the liquid crystal layer LC.

The array substrate AR comprises scanning lines GL (GL1, GL2, . . . ) extending in the first direction X in which the pixels PX are arranged, signal lines SL (SL1, SL2, . . . ) extending in the second direction Y in which the pixels PX are arranged, pixel switches SW provided near the intersections of the scanning lines GL and the signal lines SL.

Each pixel switch SW comprises a thin-film transistor (TFT). Each pixel switch SW comprises a first electrode electrically connected to a corresponding scanning line GL. Each pixel switch SW comprises a second electrode electrically connected to a corresponding signal line SL. Each pixel switch SW comprises a third electrode electrically connected to a corresponding pixel electrode PE. Here, the first electrode functions as a gate electrode. One of the second and third electrodes functions as a source electrode. The other one of the second and third electrodes functions as a drain electrode.

The driver IC 1 comprises a signal line driving circuit SD. The array substrate AR comprises a scanning line driving circuit GD (including a left scanning line driving circuit GD-L and a right scanning line driving circuit GD-R). The scanning lines GL are electrically connected to the output terminals of the scanning line driving circuit GD. The signal lines SL are electrically connected to the output terminals of the signal line driving circuit SD. The scanning line driving circuit GD, the driver IC 1 (signal line driving circuit SD) and the control module CM function as a driving unit DR which drives the pixels PX. A display driver comprises the driving unit DR.

The scanning line driving circuit GD and the driver IC 1 are provided in the non-display area NDA. The scanning line driving circuit GD applies on-voltage to the scanning lines GL in series, and applies on-voltage to the gate electrodes of the pixel switches SW electrically connected to the selected scanning lines GL. The pixel switch SW whose gate electrode in supplied with on-voltage is brought into conduction between the source electrode and the drain electrode. The signal line driving circuit SD supplies a corresponding output signal to each signal line SL. The signal supplied to each signal line SL is supplied to corresponding pixel electrode PE via the pixel switch SW which is brought into conduction between the source electrode and the drain electrode.

The operation of the scanning line driving circuit GD and the signal line driving circuit SD is controlled by the control module CM provided outside the liquid crystal display panel PNL. The control module CM applies a common voltage Vcom to the common electrode COM. However, in a manner different from that of the present embodiment, a common voltage Vcom may be applied from the driver IC 1 to the common electrode COM. Further, the control module CM controls the operation of the backlight unit BL.

To reduce the drive power, the control module CM has a function of low-frequency driving in addition to a function of normal driving. The time interval for rewriting a video signal (image signal) for the same pixel electrode PE is called a frame period. Its inverse is called a drive frequency or frame frequency. In the present application, these definitions are also applied to intermittent driving.

It is assumed that the standard frame frequency of the liquid crystal display device DSP is 60 Hz (in other words, the video signal of each of the pixels PX is rewritten every 1/60 of a second). When a moving image is displayed, the standard frame frequency of 60 Hz is applied. For example, when a still image in which the visibility of a moving image is not so important is displayed, the driving unit including the control module CM performs low-frequency driving.

The driving unit performs write operation for one frame (in other words, scanning from the top to bottom of the screen) in 1/60 of a second. Subsequently, a break period of, for example, 2/60 of a second, 3/60 of a second, 4/60 of a second, 5/60 of a second, 9/60 of a second, 11/60 of a second, 14/60 of a second, 19/60 of a second, 29/60 of a second or 59/60 of a second, is provided. When the write operation of the control module CM is stopped in the break period, the power consumed in the period is substantially zero. Thus, the circuit consumed power as the mean time including the write period is reduced to ⅓ to 1/60.

In the present embodiment, the driving unit drives the same pixel electrode PE with a drive frequency of 1 to 20 Hz.

In the present embodiment, the liquid crystal display device DSP is a liquid crystal display device in a fringe-field switching (FFS) mode for generating an electric field in the liquid crystal layer LC by the difference in potential between the common electrode COM and each pixel electrode PE and controlling the direction of alignment of liquid crystal molecules of the liquid crystal layer. The amount of transmitted light emitted from the backlight unit BL is controlled by the direction of alignment of liquid crystal molecules.

A capacitance component Cs0 is generated in the portion where each pixel electrode PE faces the common electrode COM across the intervening insulating layer L1. Moreover, a storage capacitance component Cs1 corresponding to an electric field leading to the inside of the liquid crystal layer LC and liquid crystal capacitance Clc are present. When the total capacitance present between each pixel electrode PE and the common electrode COM is defined as Cs, capacitance Cs can be shown by the equivalent circuit of FIG. 3.

Now, this specification explains the display driving performed when an image is displayed in the liquid crystal display device DSP in the above FFS mode.

This specification explains an off-state in which no voltage is applied to the liquid crystal layer LC. The off-state is equivalent to a state in which there is no difference in potential between each pixel electrode PE and the common electrode COM. In this off-state, the liquid crystal molecules included in the liquid crystal layer LC are initially aligned in one direction within the X-Y plane by the alignment controlling force of the alignment films AL1 and AL2. The backlight emitted from the backlight unit BL partially passes through the polarizer of the first optical element OD1, and enters the liquid crystal display panel PNL. The light having entered the liquid crystal display panel PNL is linearly polarized light perpendicular to the absorptive axis of the polarizer. There is little change in the state of polarization of the linearly polarized light when the light passes through the liquid crystal display panel PNL in an off-state. Thus, the linearly polarized light having passed through the liquid crystal display panel PNL is mostly absorbed by the polarizer of the second optical element OD2 (black display). The mode in which black display is applied to the liquid crystal display panel PNL in an off-state is called a normally black mode.

Now, this specification explains an on-state in which voltage is applied to the liquid crystal layer LC. The on-state is equivalent to a state in which there is a difference in potential between each pixel electrode PE and the common electrode COM. Thus, a common voltage Vcom is applied to the common electrode COM. Each pixel electrode PE is supplied with a video signal Vsig forming a difference in potential from the common voltage. In this way, a fringe electric field is formed between each pixel electrode PE and the common electrode COM in the on-state.

In this on-state, the liquid crystal molecules are aligned in a direction different from that of initial alignment in the X-Y plane. In the on-state, linearly polarized light perpendicular to the absorptive axis of the polarizer of the first optical element OD1 enters the liquid crystal display panel PNL. The state of polarization of the light changes in accordance with the alignment state of liquid crystal molecules when the light passes through the liquid crystal layer LC. Thus, in the on-state, at least part of the light having passed through the liquid crystal layer LC goes through the polarizer of the second optical element OD2 (white display).

As described above, low-frequency driving is used to reduce the number of writes to the pixel electrodes PE (in other words, the number of switches of the pixel switches SW from an off-state to an on-state). In this way, it is possible to obtain an effect of reducing the circuit consumed power.

The storage period in one frame in the case of low-frequency driving is longer than that in the case of normal driving with 60 Hz. Thus, the voltage applied to the liquid crystal layer LC is decreased by the long storage period. A flicker is easily generated. Further, an image is easily burned in. The burn-in (image burn-in) refers to a phenomenon in which a fixed image remains on the screen.

Experimental results by the inventors of the present application show that the generation of a flicker or image burn-in varies depending on the environment of the liquid crystal display panel PNL such as the surrounding temperature of the liquid crystal display panel PNL, the time in which the backlight illuminates the liquid crystal display panel PNL, and the luminance of the backlight.

However, in the present embodiment, it is possible to obtain a liquid crystal display device DSP which can prevent generation of a flicker or image burn-in even when low-frequency driving is used to display an image. This liquid crystal display device DSP is exemplarily explained in examples 1 to 8.

### Example 1

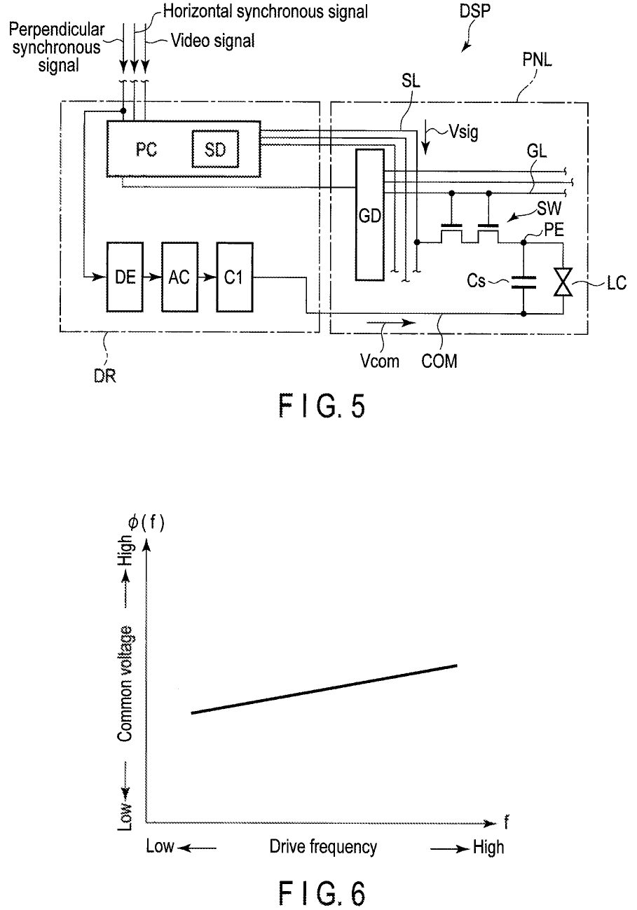

Now, this specification explains the liquid crystal display device DSP according to example 1. FIG. 5 is a circuit diagram showing some structures of the liquid crystal display device DSP according to example 1 of the present embodiment. For example, the liquid crystal display device DSP of example 1 comprises a circuit which automatically controls the common voltage Vcom in accordance with the drive frequency.

The driving unit which drives the liquid crystal display panel PNL comprises a video signal processing circuit PC, a determination circuit DE which determines the drive frequency, a calculation circuit AC as a derivation circuit which derives a common voltage Vcom, and a digital-analog converter C1. The driving unit DR is configured to apply a common voltage Vcom to the common electrode COM and alternately supply a video signal Vsig having a first polarity and a video signal Vsig having a second polarity different from the first polarity to the pixel electrode PE with respect to each frame period. For example, the first polarity is positive, and the second polarity is negative. In example 1, the driving unit DR is configured to adjust the common voltage Vcom applied to the common electrode COM based on the information of the drive frequency of a video signal.

The video signal processing circuit PC includes the above signal line driving circuit SD. A video signal, a perpendicular synchronous signal and a horizontal synchronous signal are input to the video signal processing circuit PC from outside. The perpendicular synchronous signal and the horizontal synchronous signal are associated with the video signal. The video signal processing circuit PC appropriately transmits a video signal Vsig to the liquid crystal display panel PNL based on these signals.

The perpendicular synchronous signal is also supplied to the determination circuit DE. The determination circuit DE determines the drive frequency based on the perpendicular synchronous signal.

The calculation circuit AC is configured to derive a common voltage Vcom based on the drive frequency determined in the determination circuit DE. In example 1, the calculation circuit AC is configured to calculate a common voltage Vcom from the drive frequency. Specifically, the calculation circuit AC is configured to calculate a common voltage Vcom based on the drive frequency determined in the determination circuit DE. In this way, for example, the liquid crystal display device DSP is capable of deriving a common voltage Vcom without a storage unit including the information of a common voltage Vcom corresponding to the drive frequency of the video signal. Thus, it is possible to prevent increase in the storage capacity of the liquid crystal display device DSP.

The digital-analog converter C1 is configured to convert the common voltage Vcom derived in the calculation circuit AC into an analog common voltage Vcom and apply the analog common voltage Vcom to the common electrode COM. In example 1, the digital-analog converter C1 is configured to convert the calculated value of the calculation circuit AC into an analog signal.

In this way, the driving unit DR is capable of automatically controlling the common voltage Vcom applied to the common electrode COM in accordance with the drive frequency of a video signal Vsig. Alternatively, in the case of driving the liquid crystal display panel PNL, a common voltage Vcom programmed in advance is output in accordance with the drive frequency determined based on a perpendicular synchronous signal.

FIG. 6 is a graph showing a change in the common voltage Vcom in accordance with the drive frequency in the liquid crystal display device DSP of example 1.

As shown in FIG. 6, the calculation circuit AC performs calculation such that, the common voltage Vcom is increased with increasing drive frequency, and the common voltage Vcom is decreased with decreasing drive frequency. In example 1, the common voltage Vcom is a function of the drive frequency. When the drive frequency is f, and the common voltage Vcom is φ(f), φ(f)=af+b, where a and b are constants. As described above, when the drive frequency changes, the common voltage Vcom is adjusted so as to correspond to the drive frequency. In this way, it is possible to prevent a flicker or image burn-in.

### Example 2

Now, this specification explains the liquid crystal display device DSP according to example 2.

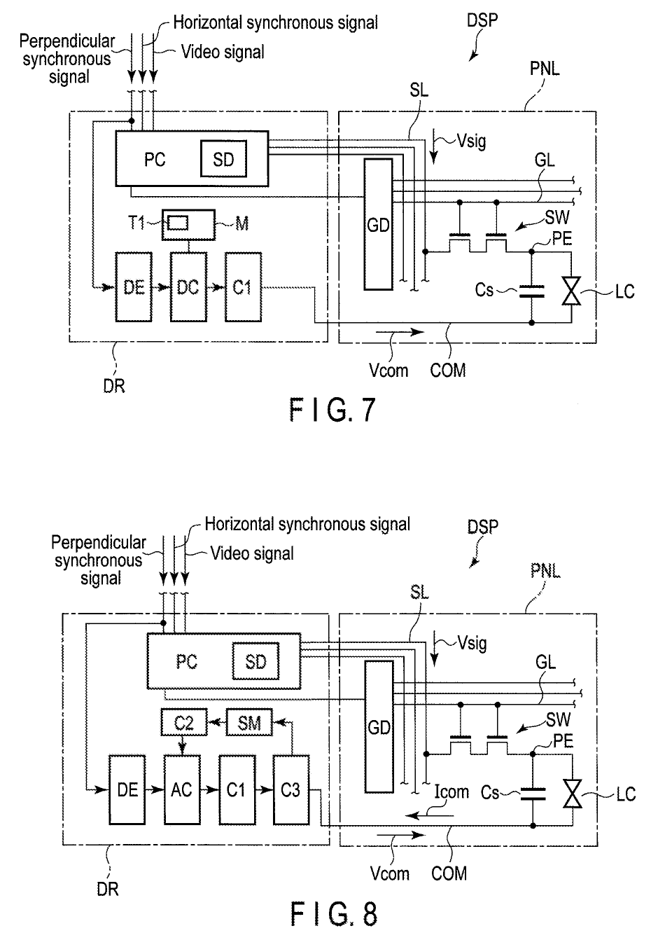

The driving unit DR of the liquid crystal display device DSP of example 2 is different from that of example 1 in respect that the driving unit DR comprises a derivation circuit DC and a storage unit M in place of the calculation circuit AC. FIG. 7 is a circuit diagram showing some structures of the liquid crystal display device DSP according to example 2 of the present embodiment.

As shown in FIG. 7, the driving unit DR comprises the storage unit M. The storage unit M includes a table T1 in which the information of common voltages Vcom associated with drive frequencies is stored. The derivation circuit DC is capable of selecting a common voltage Vcom corresponding to the drive frequency determined in the determination circuit DE from the storage unit M (table T1) when deriving the common voltage Vcom.

In the above structure, example 2 can reduce the amount of calculation to derive a common voltage Vcom in comparison with example 1.

In the information stored in the table T1, drive frequencies are associated with common voltages Vcom one by one. Alternatively, in the information, drive frequencies in a specific range are associated with a single common voltage Vcom one by one. The amount of storage in the storage unit M in the latter case is less than that in the former case. Thus, in the latter case, it is possible to further prevent increase in the storage capacity of the liquid crystal display device DSP.

The liquid crystal display device DSP of example 2 may include a structure unique to the liquid crystal display device DSP of example 1, and may be configured to function in a manner similar to that of example 1.

### Example 3

Now, this specification explains the liquid crystal display device DSP according to example 3.

The driving unit DR of the liquid crystal display device DSP of example 3 is different from that of example 1 in respect that the driving unit DR further comprises an analog-digital converter C2, a smoothing circuit SM and a conversion circuit C3. FIG. 8 is a circuit diagram showing some structures of the liquid crystal display device DSP according to example 3 of the above embodiment.

As shown in FIG. 8, the conversion circuit C3 is configured to convert the common current Icom supplied from the common electrode COM into voltage. The smoothing circuit SM is configured to smooth the voltage obtained in the conversion circuit C3. The analog-digital converter C2 is configured to convert the voltage smoothed in the smoothing circuit SM into digital voltage. The calculation circuit AC (driving unit DR) is configured to adjust the common voltage Vcom applied to the common electrode COM such that the mean digital voltage output from the analog-digital converter C2 is zero.

As described above, the driving unit DR of example 3 comprises a circuit which automatically controls the common voltage Vcom in accordance with the common current Icom. The driving unit DR is configured to perform fine adjustment for the common voltage Vcom such that the mean common current Icom is zero as necessary.

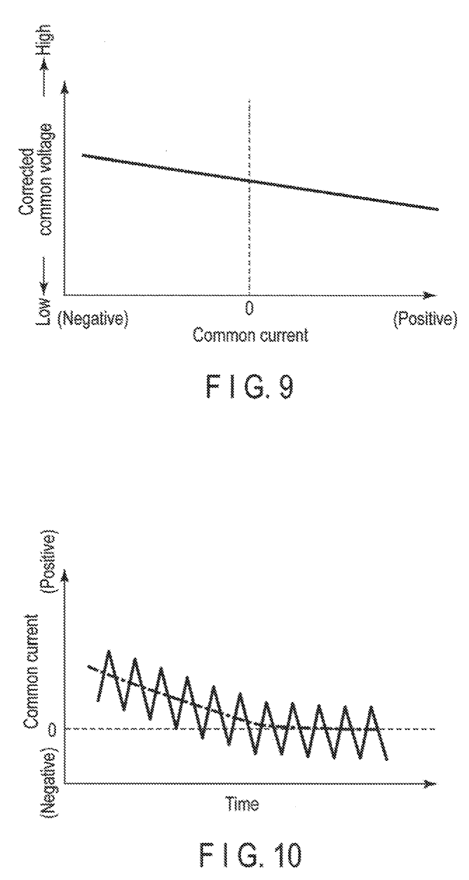

FIG. 9 is a graph showing a change in the corrected common voltage Vcom in accordance with the common current Icom in the liquid crystal display device DSP of example 3.

As shown in FIG. 9, for example, when the common current Icom is positive, the common voltage Vcom can be decreased. When the common current Icom is negative, the common voltage Vcom can be increased.

FIG. 10 is a graph showing a change in the common current Icom in accordance with time in the liquid crystal display device DSP of example 3.

As shown in FIG. 10, even when the drive frequency changes, the driving unit DR of example 3 performs control such that the mean common current Icom is zero. Since polarity inversion driving is performed, the direction of the common current Icom is reversed based on each frame period. The driving unit DR of example 3 is capable of performing fine adjustment for the common voltage Vcom as described above. Thus, a flicker can be further prevented.

The liquid crystal display device DSP of example 3 includes the structure of the liquid crystal display device DSP of example 1. Therefore, the liquid crystal display device DSP of example 3 may have a function similar to that of example 1. Alternatively, the liquid crystal display device DSP of example 3 may include a structure unique to the liquid crystal display device DSP of example 2, and may be configured to function in a manner similar to that of example 2.

### Example 4

Now, this specification explains the liquid crystal display device DSP according to example 4.

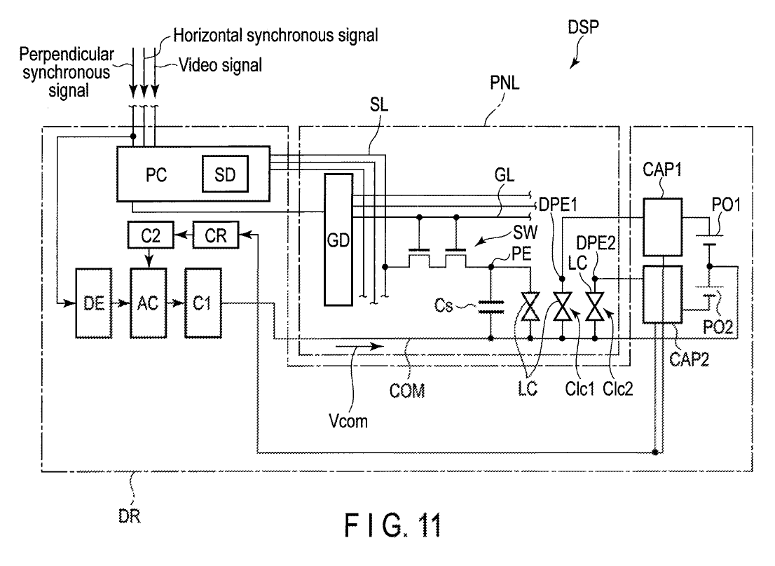

The driving unit DR of the liquid crystal display device DSP of example 4 is different from that of example 1 in terms of the structure of the liquid crystal display panel PNL and the structure of the driving unit DR. FIG. 11 is a circuit diagram showing some structures of the liquid crystal display device DSP according to example 4 of the present embodiment.

As shown in FIG. 11, the liquid crystal display panel PNL further comprises a first dummy pixel electrode DPE1 and a second dummy pixel electrode DPE2. As seen in plan view, the first dummy pixel electrode DPE1 and the second dummy pixel electrode DPE2 are located outside the display area DA, and overlap the liquid crystal layer LC and the common electrode COM. The first dummy pixel electrode DPE1 is capacitively coupled to the common electrode COM via the liquid crystal layer LC. The second dummy pixel electrode DPE2 is capacitively coupled to the common electrode COM via the liquid crystal layer LC.

The driving unit DR further comprises a first power source PO1, a second power source PO2, a first measurement unit CAP1, a second measurement unit CAP2, a comparative circuit CR and the analog-digital converter C2.

The first power source PO1 is used to apply bias voltage having the first polarity to the first dummy pixel electrode DPE1. The second power source PO02 is used to apply bias voltage having the second polarity to the second dummy pixel electrode DPE2. In present example, for example, the first polarity is positive, and the second polarity is negative.

The first measurement unit CAP1 is configured to apply bias voltage having the first polarity from the first power source PO1 to the first dummy pixel electrode DPE1 and measure first liquid crystal capacitance Clc1 formed between the first dummy pixel electrode DPE1 to which the bias voltage having the first polarity is applied and the common electrode COM.

The second measurement unit CAP2 is configured to apply bias voltage having the second polarity from the second power source PO02 to the second dummy pixel electrode DPE2 and measure second liquid crystal capacitance Clc2 formed between the second dummy pixel electrode DPE2 to which the bias voltage having the second polarity is applied and the common electrode COM.

The comparative circuit CR is connected to the first measurement unit CAP1 and the second measurement unit CAP2, and is configured to compare the first liquid crystal capacitance Clc1 with the second liquid crystal capacitance Clc2. The analog-digital converter C2 is configured to convert a voltage signal output from the comparative circuit CR into digital voltage. The calculation circuit AC (driving unit DR) is configured to adjust the common voltage Vcom applied to the common electrode COM such that the first liquid crystal capacitance Clc1 is equal to the second liquid crystal capacitance Clc2.

As described above, the liquid crystal display device DSP of example 4 comprises circuits which monitor the alignment state of the liquid crystal and automatically control the common voltage Vcom. When the common voltage Vcom is outside an optimal range, a difference is generated between the first liquid crystal capacitance Clc1 and the second liquid crystal capacitance Clc2. The driving unit DR is configured to detect the difference in the comparative circuit CR and perform fine adjustment for the common voltage Vcom as necessary such that the difference in liquid crystal capacitance is zero.

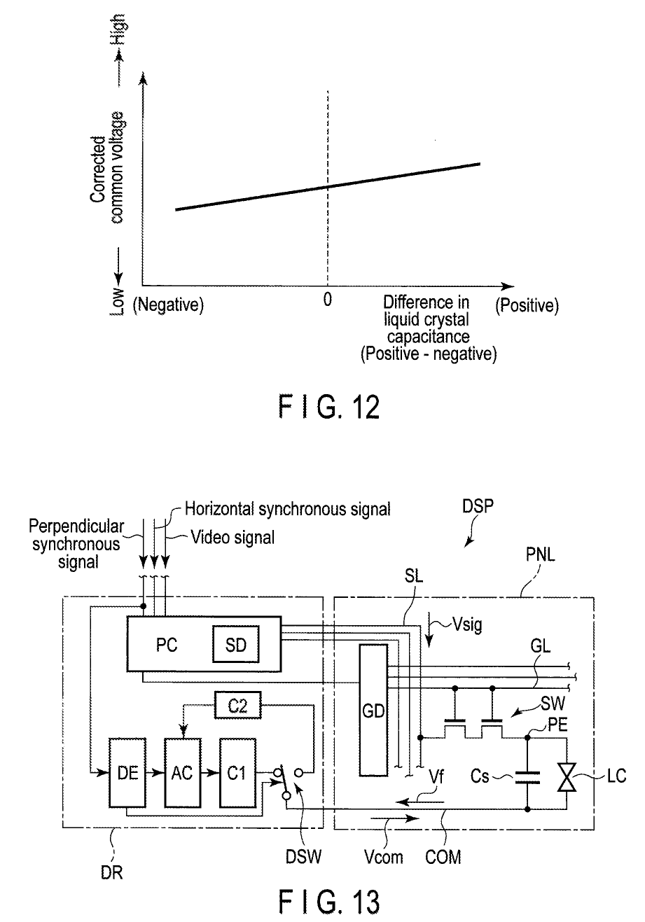

FIG. 12 is a graph showing a change in the corrected common voltage Vcom in accordance with the difference in liquid crystal capacitance in the liquid crystal display device DSP of example 4.

As shown in FIG. 12, when the difference between the first liquid crystal capacitance Clc1 and the second liquid crystal capacitance Clc2 is positive, the driving unit DR increases the common voltage Vcom. When the difference between the first liquid crystal capacitance Clc1 and the second liquid crystal capacitance Clc2 is negative, the driving unit DR decreases the common voltage Vcom. The driving unit DR of example 4 is capable of performing fine adjustment for the common voltage Vcom as stated above. Thus, a flicker can be further prevented.

The liquid crystal display device DSP of example 4 includes the structure of the liquid crystal display device DSP of example 1. Therefore, the liquid crystal display device DSP of example 4 may have a function similar to that of example 1. Alternatively, the liquid crystal display device DSP of example 4 may include a structure unique to the liquid crystal display device DSP of example 2, and may be configured to function in a manner similar to that of example 2. Alternatively, the liquid crystal display device DSP of example 4 may include a structure unique to the liquid crystal display device DSP of example 3, and may be configured to function in a manner similar to that of example 3.

### Example 5

Now, this specification explains the liquid crystal display device DSP according to example 5.

The driving unit DR of the liquid crystal display device DSP of example 5 is different from that of example 1 in terms of the structure of the driving unit DR. FIG. 13 is a circuit diagram showing some structures of the liquid crystal display device DSP according to example 5 of the present embodiment.

As shown in FIG. 13, the driving unit DR further comprises the analog-digital converter C2 and a switch DSW. The analog-digital converter C2 is configured to convert voltage Vf supplied from the common electrode COM into digital voltage. The switch DSW switches the connection state to a first state or a second state. In the first state, the common electrode COM is connected to the digital-analog converter C1. In the second state, the common electrode COM is connected to the analog-digital converter C2.

The switch DSW switches the connection state to the first state in each drive period in which a video signal Vsig is supplied to the pixel electrode PE. The switch DSW switches the connection state to the second state in each period between drive periods. In this way, the voltage Vf of the common electrode COM in a floating state can be applied to the analog-digital converter C2. The calculation circuit (derivation circuit) AC adjusts the common voltage Vcom applied to the common electrode COM based on the digital voltage obtained in the analog-digital converter C2.

As described above, the liquid crystal display device DSP of example 5 comprises circuits which monitor the voltage Vf of the common electrode COM temporarily in a floating state and automatically control the common voltage Vcom. The monitored voltage Vf of the common electrode COM is optimal. Thus, the driving unit DR corrects the common voltage Vcom currently set, and applies the corrected common voltage Vcom to the common electrode COM in the next frame period.

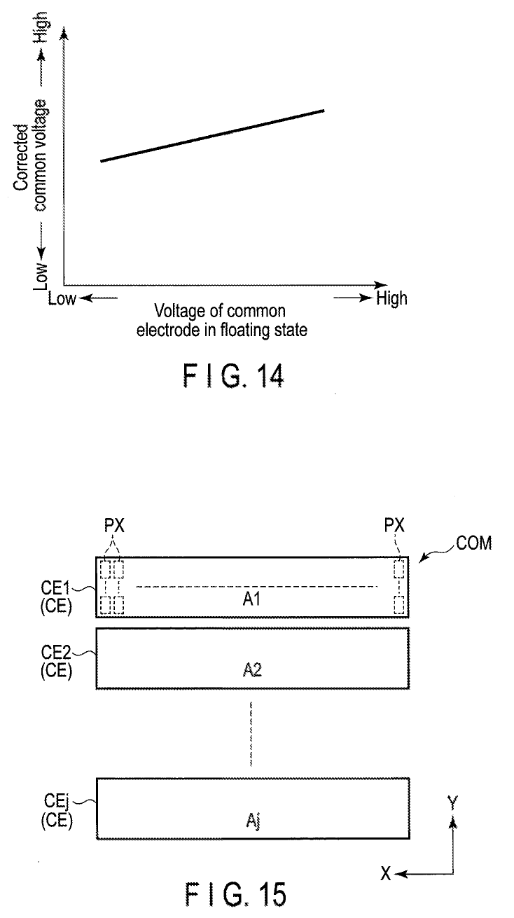

FIG. 14 is a graph showing a change in the corrected common voltage Vcom in accordance with the voltage Vf of the common electrode COM in a floating state in the liquid crystal display device DSP of example 5. As shown in FIG. 14, when the voltage Vf of the common electrode COM in a floating state is increased, the driving unit DR increases the common voltage Vcom. When voltage Vf is decreased, the driving unit DR decreases the common voltage Vcom. The driving unit DR of example 5 is capable of performing fine adjustment for the common voltage Vcom as stated above. Thus, a flicker can be further prevented.

The liquid crystal display device DSP of example 5 includes the structure of the liquid crystal display device DSP of example 1. Therefore, the liquid crystal display device DSP of example 5 may have a function similar to that of example 1. Alternatively, the liquid crystal display device DSP of example 5 may include a structure unique to the liquid crystal display device DSP of example 2, and may be configured to function in a manner similar to that of example 2. Alternatively, the liquid crystal display device DSP of example 5 may include a structure unique to the liquid crystal display device DSP of example 3, and may be configured to function in a manner similar to that of example 3. Alternatively, the liquid crystal display device DSP of example 5 may include a structure unique to the liquid crystal display device DSP of example 4, and may be configured to function in a manner similar to that of example 4.

### Example 6

Now, this specification explains the liquid crystal display device DSP according to example 6.

The driving unit DR of the liquid crystal display device DSP of example 6 is different from that of example 1 in terms of the structure of the liquid crystal display panel PNL and the structure of the driving unit DR. FIG. 15 is a plan view showing the common electrode COM of the liquid crystal display device DSP according to example 6 of the present embodiment.

As shown in FIG. 15, the common electrode COM comprises a plurality of split electrodes CE. Each of the split electrodes CE is shaped like a band. The split electrodes CE extend in the first direction X, and are arranged at intervals in the second direction Y. The split electrodes CE extend in parallel with the scanning lines GL, and are arranged in the extension direction of the signal lines SL. Each split electrode CE is shared by the pixels PX of a plurality of rows. The common electrode COM comprises j split electrodes CE from split electrode CE1 to split electrode CEj, where j is an integer greater than or equal to two. The area facing split electrode CE1 is defined as a first area A1. The area facing split electrode CE2 is defined as a second area A2. The area facing split electrode CEj is defined as a j^{th} area Aj.

In each frame period, the pixels PX of the first area A1 are driven in the first drive period. The pixels PX of the second area A2 are driven in the second drive period. The pixels PX of the j^{th} area Aj are driven in the last drive period.

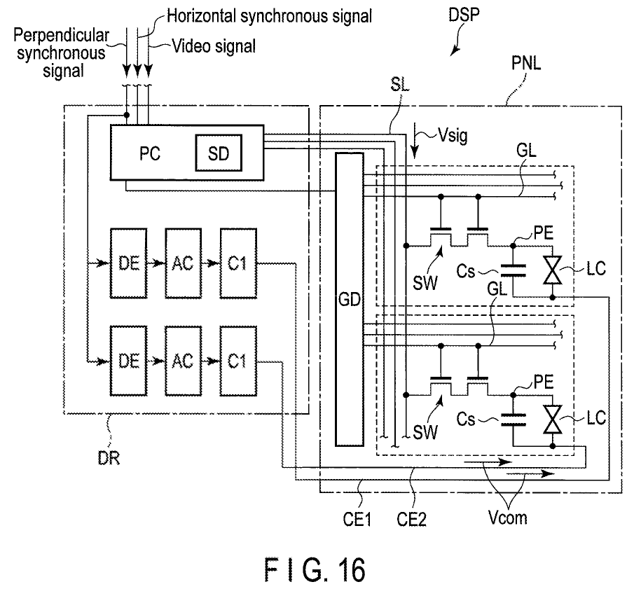

FIG. 16 is a circuit diagram showing some structures of the liquid crystal display device DSP of example 6.

As shown in FIG. 16, the driving unit DR is configured to adjust the common voltage Vcom applied to each split electrode CE. Specifically, the driving unit DR comprises j sets each including the determination circuit DE, the calculation circuit (derivation circuit) AC and the digital-analog converter C1. Thus, the number of sets each including the determination circuit DE, the calculation circuit AC and the digital-analog converter C1 is equal to the number of split electrodes CE. The driving unit DR is capable of adjusting the common voltage Vcom applied to each individual split electrode CE.

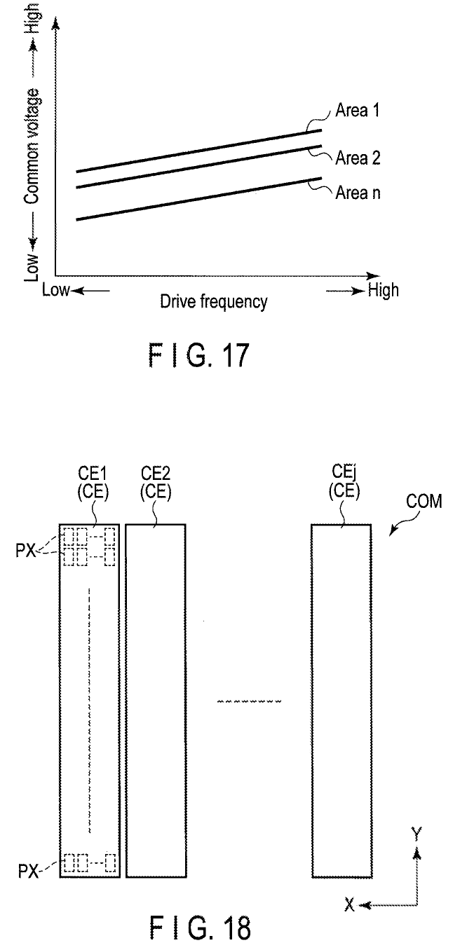

FIG. 17 is a graph showing a change in the common voltage Vcom in accordance with the drive frequency in each area A of the liquid crystal display device DSP of example 6.

As shown in FIG. 17, the common voltage Vcom applied to each split electrode CE is controlled so as to be optimal in accordance with the drive frequency. For example, the common voltage Vcom applied to split electrode CE1 of the first area A1 is high. The common voltage Vcom applied to split electrode CEj of the j^{th} area Aj is relatively low. In this way, the difference in potential between the pixel electrodes PE and split electrode CE1 driven in the first drive period can be smaller than that between the pixel electrodes PE and split electrode CEj driven in the last drive period. The driving unit DR of example 6 is capable of performing fine adjustment for the common voltage Vcom applied to each split electrode CE as explained above. Thus, a flicker can be further prevented.

The liquid crystal display device DSP of example 6 includes the structure of the liquid crystal display device DSP of example 1. Therefore, the liquid crystal display device DSP of example 6 may have a function similar to that of example 1. Alternatively, the liquid crystal display device DSP of example 6 may include a structure unique to the liquid crystal display device DSP of example 2, and may be configured to function in a manner similar to that of example 2. Alternatively, the liquid crystal display device DSP of example 6 may include a structure unique to the liquid crystal display device DSP of example 3, and may be configured to function in a manner similar to that of example 3. Alternatively, the liquid crystal display device DSP of example 6 may include a structure unique to the liquid crystal display device DSP of example 4, and may be configured to function in a manner similar to that of example 4. Alternatively, the liquid crystal display device DSP of example 6 may include a structure unique to the liquid crystal display device DSP of example 5, and may be configured to function in a manner similar to that of example 5.

### Example 7

Now, this specification explains the liquid crystal display device DSP according to example 7.

The driving unit DR of the liquid crystal display device DSP of example 7 is different from that of example 6 in terms of the structure of the liquid crystal display panel PNL. FIG. 18 is a plan view showing the common electrode COM of the liquid crystal display device DSP according to example 7 of the present embodiment.

As shown in FIG. 18, each of the split electrodes CE is shaped like a band. The split electrodes CE extend in the second direction Y, and are arranged at intervals in the first direction X. The split electrodes CE extend in parallel with the signal lines SL, and are arranged in the extension direction of the scanning lines GL. Each split electrode CE is shared by the pixels PX of a plurality of columns.

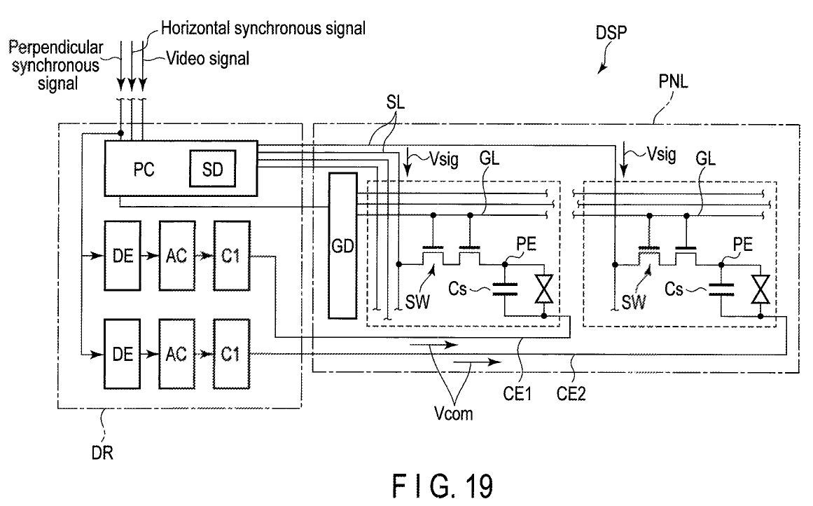

FIG. 19 is a circuit diagram showing some structures of the liquid crystal display device of example 7.

As shown in FIG. 19, the driving unit DR of example 7 comprises j sets each including the determination circuit DE, the calculation circuit (derivation circuit) AC and the digital-analog converter C1 in the same manner as that of the driving unit of example 6. Thus, the number of sets each including the determination circuit DE, the calculation circuit AC and the digital-analog converter C1 is equal to the number of split electrodes CE. The driving unit DR of example 7 is capable of performing fine adjustment for the common voltage Vcom applied to each split electrode CE in the same manner as that of example 6. In this way, a flicker can be further prevented.

### Example 8

Now, this specification explains the liquid crystal display device DSP according to example 8.

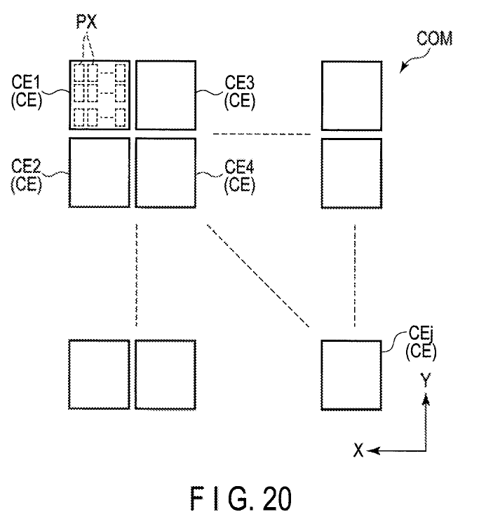

The driving unit DR of the liquid crystal display device DSP of example 8 is different from that of example 6 in terms of the structure of the liquid crystal display panel PNL. FIG. 20 is a plan view showing the common electrode COM of the liquid crystal display device DSP according to example 8 of the present embodiment.

As shown in FIG. 20, each of the split electrodes CE is quadrangle. The split electrodes CE are arranged in matrix in the first direction X and the second direction Y. The split electrodes CE are arranged along the signal lines SL and the scanning lines GL. Each split electrode CE is shared by the pixels PX of a plurality of columns.

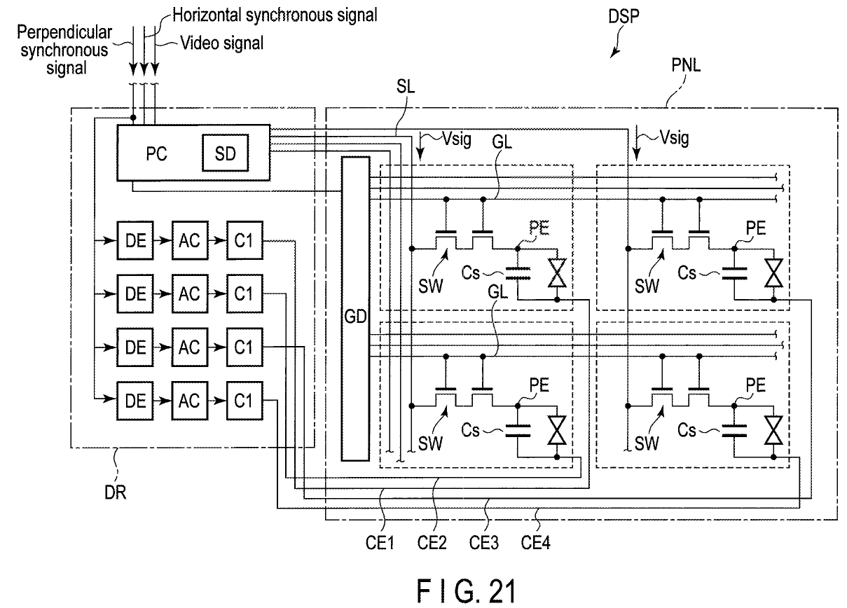

FIG. 21 is a circuit diagram showing some structures of the liquid crystal display device according to example 8.

As shown in FIG. 21, the driving unit DR of example 8 comprises j sets each including the determination circuit DE, the calculation circuit (derivation circuit) AC and the digital-analog converter C1 in the same manner as that of the driving unit of example 6. Thus, the number of sets each including the determination circuit DE, the calculation circuit AC and the digital-analog converter C1 is equal to the number of split electrodes CE. The driving unit DR of example 8 is capable of performing fine adjustment for the common voltage Vcom applied to each split electrode CE in the same manner as that of example 6. In this way, a flicker can be further prevented.

According to the embodiments having the above structure, it is possible to obtain a liquid crystal display device DSP with excellent display quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The above embodiments are disclosed with the examples of a liquid crystal display device. However, the embodiments are not limited to the application to the above liquid crystal display device, and may be applied to various types of liquid crystal display devices.

What is claimed is:

1. A display driver,
with respect to a liquid crystal display panel comprising a pixel electrode, a common electrode and a liquid crystal layer,
the display driver comprising a driving unit which applies a common voltage to the common electrode, and alternately supplies a video signal having a first polarity and the video signal having a second polarity different from the first polarity to the pixel electrode in each frame period, wherein
the driving unit adjusts the common voltage applied to the common electrode based on information of a drive frequency of the video signal.

2. The display driver of claim 1, wherein
the driving unit comprises:
a determination circuit which determines the drive frequency;
a derivation circuit which derives the common voltage based on the drive frequency determined in the determination circuit; and
a digital-analog converter which converts the common voltage derived in the derivation circuit into an analog common voltage, and applies the analog common voltage to the common electrode, and
the driving unit automatically controls the common voltage applied to the common electrode in accordance with the drive frequency.

3. The display driver of claim 2, wherein
the derivation circuit is a calculation circuit which calculates the common voltage based on the drive frequency determined in the determination circuit.

4. The display driver of claim 3, wherein
the common voltage is a function of the drive frequency.

5. The display driver of claim 2, further comprising:
a storage unit in which information of the common voltage corresponding to the drive frequency is stored, wherein
when the derivation circuit derives the common voltage, the derivation circuit selects the common voltage corresponding to the drive frequency determined in the determination circuit from the storage unit.

6. The display driver of claim 1, wherein
the driving unit comprises:
a conversion circuit which converts a common current supplied from the common electrode into voltage;
a smoothing circuit which smoothes the voltage obtained in the conversion circuit; and
an analog-digital converter which converts the voltage smoothed in the smoothing circuit into digital voltage, and
the driving unit adjusts the common voltage applied to the common electrode such that a mean value of the digital voltage is zero.

7. The display driver of claim 1, wherein
the driving unit comprises:
a determination circuit which determines the drive frequency;
a derivation circuit which derives the common voltage based on the drive frequency determined in the determination circuit;
a digital-analog converter which converts the common voltage derived in the derivation circuit into an analog common voltage, and applies the analog common voltage to the common electrode;
an analog-digital converter which converts the voltage from the common electrode into digital voltage; and
a switch which switches a connection state to a first state for connecting the common electrode to the digital-analog converter or a second state for connecting the common electrode to the analog-digital converter,
the switch switches the connection state to the first state in each drive period in which the video signal is supplied to the pixel electrode, switches the connection state to the second state in a period between the drive periods, and applies the voltage of the common electrode in a floating state to the analog-digital converter, and
the derivation circuit adjusts the common voltage applied to the common electrode based on the digital voltage obtained in the analog-digital converter.

8. A liquid crystal display device comprising:
a liquid crystal display panel comprising a pixel electrode, a common electrode and a liquid crystal layer; and
a display driver comprising a driving unit which applies a common voltage to the common electrode, and alternately supplies a video signal having a first polarity and the video signal having a second polarity different from the first polarity to the pixel electrode in each frame period, wherein
the driving unit adjusts the common voltage applied to the common electrode based on information of a drive frequency of the video signal.

9. The liquid crystal display device of claim 8, wherein
the liquid crystal display panel further comprises a first dummy pixel electrode capacitively coupled to the common electrode via the liquid crystal layer, and a second dummy pixel electrode capacitively coupled to the common electrode via the liquid crystal layer,
the display driver comprises:
a first measurement unit which measures first liquid crystal capacitance formed between the first dummy pixel electrode to which bias voltage having the first polarity is applied and the common electrode;
a second measurement unit which measures second liquid crystal capacitance formed between the second dummy pixel electrode to which bias voltage having the second polarity is applied and the common electrode; and
a comparative circuit which compares the first liquid crystal capacitance with the second liquid crystal capacitance, and
the display driver adjusts the common voltage applied to the common electrode such that the first liquid crystal capacitance is equal to the second liquid crystal capacitance.

10. The liquid crystal display device of claim 8, wherein
the common electrode comprises a plurality of split electrodes, and
the display driver adjusts the common voltage applied to each individual split electrode.

11. The liquid crystal display device of claim 10, wherein
the liquid crystal display panel further comprises a signal line connected to the pixel electrode and supplied with the video signal, and a scanning line intersecting the signal line, and
the split electrodes extend in parallel with the scanning line, and are arranged in an extension direction of the signal line.

12. The liquid crystal display device of claim 10, wherein
the liquid crystal display panel further comprises a signal line connected to the pixel electrode and supplied with the video signal, and a scanning line intersecting the signal line, and
the split electrodes extend in parallel with the signal line, and are arranged in an extension direction of the scanning line.
